(19) United States
(12) Patent Application Publication
(10) Pub. No.: US 2011/0089249 A1
(43) Pub. Date: Apr. 21, 2011

(54) THERMOSTATIC MIXING VALVE WITH PRESSURE REDUCING ELEMENT

(75) Inventor: Bruce S. Johnson, Excelsior, MN (US)

(73) Assignee: Honeywell International Inc., Morristown, NJ (US)

(21) Appl. No.: 12/603,369

(22) Filed: Oct. 21, 2009

(51) Int. Cl. G05D 23/13

(52) U.S. Cl. 236/12.14; 236/12.2

(57) ABSTRACT

A thermostatic mixing valve for mixing a hot fluid and a cold fluid to produce a tempered mixed fluid stream is disclosed. In one illustrative embodiment, the thermostatic mixing valve includes a cold fluid inlet for passing a flow of cold fluid, a hot fluid inlet for passing a flow of hot fluid, and an outlet for passing a flow of tempered fluid. A fluid flow regulator may be used to regulate the relative flow of cold fluid from the cold fluid inlet and hot fluid from the hot fluid inlet to produce the flow of tempered fluid at the outlet. A pressure reducing element may be situated in the hot fluid inlet upstream of the fluid flow regulator. The pressure reducing element may, for example, help increased the temperature stability of the tempered fluid at the outlet given variations in the temperature and/or pressure of the hot and/or cold fluids presented at the hot fluid inlet and the cold fluid inlet of the valve.

### TECHNICAL FIELD

The present disclosure relates generally to the field of mixing valves and more particularly to thermostatic mixing valves.

### BACKGROUND

Thermostatic mixing valves are used in a wide variety of applications for mixing fluids of dissimilar temperatures to produce a tempered fluid discharge output temperature. For example, and in one illustrative application, thermostatic mixing valves can be used in conjunction with water heaters. Water heaters are frequently used to supply hot water to desired locations within a house, office building, or other structure. To regulate the temperature of water discharged by the water heater, a thermostatic mixing valve can be connected to the hot water outlet of the water heater, allowing hot water discharged from the water heater to be mixed with cold water supplied to the structure to produce a relatively constant tempered discharge output temperature. The tempered water discharged from the mixing valve can be fed into the structure's hot water piping for subsequent use by the occupants. Often, a goal of such mixing valves is for the temperature of the mixed water to remain constant or nearly constant regardless of the temperature, pressure and/or flow rate of the hot and cold water supplied to the mixing valve.

### SUMMARY

The disclosure relates generally to thermostatic mixing valves, and more particularly to thermostatic mixing valves that are configured to provide improved temperature stability of the mixed water stream at the outlet of the mixing valve given variations in the temperature and/or pressure of the hot and/or cold water supplies to the valve, while still achieving relatively high flow rates through the valve. In one illustrative and not-limiting example, a thermostatic mixing valve may include a cold fluid inlet for passing a flow of cold fluid, a hot fluid inlet for passing a flow of hot fluid, and an outlet for passing a flow of mixed tempered fluid. A fluid flow regulator may be provided to regulate the relative flow of cold fluid from the cold fluid inlet and hot fluid from the hot fluid inlet to produce the flow of tempered fluid at the outlet of the valve. A pressure reducing element may be situated in the hot fluid inlet upstream of the fluid flow regulator. It has been found that such a pressure reducing element may, for example, help increased the temperature stability of the tempered fluid at the valve outlet given variations in the temperature and/or pressure of the hot and/or cold fluids presented at the hot fluid inlet and the cold fluid inlet of the valve.

The above summary is not intended to describe each and every disclosed embodiment or every implementation of the disclosure. The Description that follows more particularly exemplifies various illustrative embodiments.

### BRIEF DESCRIPTION OF THE DRAWINGS

The disclosure may be more completely understood in consideration of the following detailed description of various embodiments in connection with the accompanying drawings, in which:

FIG. 1 is a perspective view of an illustrative but non-limiting thermostatic mixing valve;

FIG. 2 is a partial cross-sectional view of the illustrative thermostatic mixing valve of FIG. 1, showing an illustrative pressure reducing element;

FIG. 3 is a front elevation view, with parts in cross-section, of another illustrative thermostatic mixing valve;

FIG. 4 is a cross-sectional view of the illustrative thermostatic mixing valve of FIG. 3 shown an illustrative a pressure reducing element;

FIG. 5 is a side view of another illustrative thermostatic mixing valve with a secondary hot port;

FIG. 6 is a partial cross-sectional view of the illustrative thermostatic mixing valve of FIG. 5 showing an illustrative pressure reducing element; and

FIG. 7 is a schematic view showing an illustrative water heater system employing a thermostatic mixing valve.

While the invention is amenable to various modifications and alternative forms, specifics thereof have been shown by way of example in the drawings and will be described in detail. It should be understood, however, that the intention is not to limit aspects of the invention to the particular illustrative embodiments described. On the contrary, the intention is to cover all modifications, equivalents, and alternatives falling within the spirit and scope of the invention.

### DESCRIPTION

The following description should be read with reference to the drawings in which similar elements in different drawings have similar reference numbers. The description and the drawings, which are not necessarily to scale, depict illustrative embodiments and are not intended to limit the scope of the invention. The illustrative embodiments depicted are intended only as exemplary. Selected features of any illustrative embodiment may be incorporated into other embodiments unless clearly stated to the contrary.

All numeric values are herein assumed to be modified by the term “about”, whether or not explicitly indicated. The term “about” generally refers to a range of numbers that one of skill in the art would consider equivalent to the recited value (i.e., having the same function or result). In many instances, the term “about” may be indicative as including numbers that are rounded to the nearest significant figure. The recitation of numerical ranges by endpoints is intended to include all numbers within that range (e.g., 1 to 5 includes 1, 1.5, 2, 2.75, 3, 3.80, 4, and 5).

Although some suitable dimensions, ranges and/or values pertaining to various components, features and/or specifications are disclosed, one of skill in the art, incited by the present disclosure, would understand desired dimensions, ranges and/or values may deviate from those expressly disclosed.

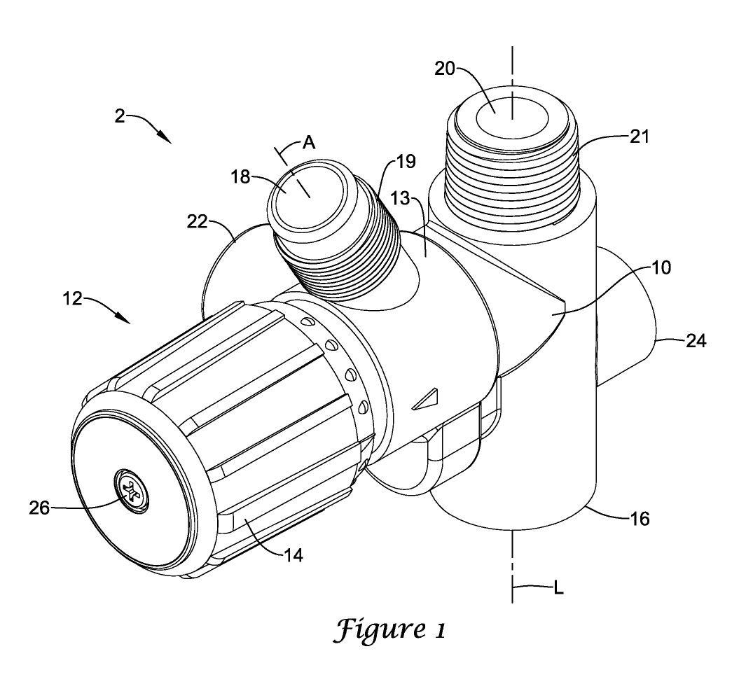

FIG. 1 is a perspective view of an illustrative but non-limiting thermostatic mixing valve 2. The illustrative thermostatic mixing valve 2 includes a valve body 10 that has a hot fluid inlet 16, a cold fluid inlet 18 and a mixed fluid outlet 20. The hot fluid inlet 16 is configured to receive fluid at an elevated temperature from, for example, a water heater, a boiler, or any other suitable heating source, and can include a tailpiece fitting (not shown) or other suitable connector for connecting the hot fluid inlet 16 to the supply (e.g. pipe) of hot fluid. Likewise, the cold fluid inlet 18 is configured to receive colder fluid from, for example, a cold water supply, and can include a tailpiece fitting 19 or other suitable connector for connecting the cold fluid inlet 18 to the supply (e.g. pipe) of colder fluid.

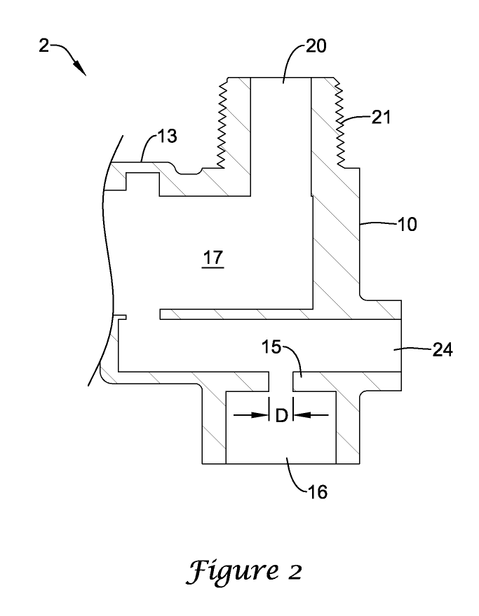

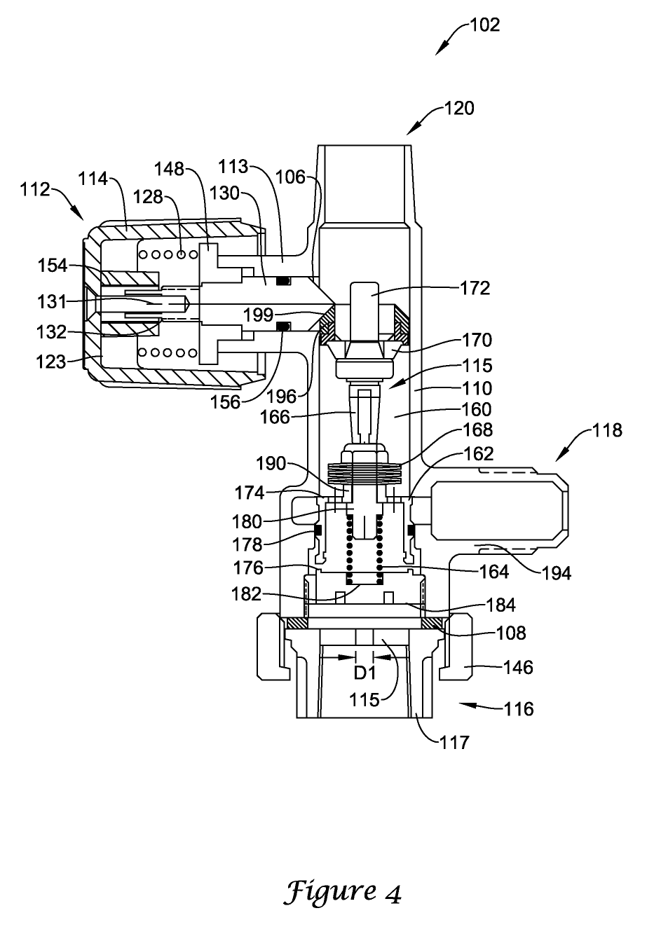

In the illustrative embodiment, the mixed fluid outlet 20 is configured to output a fluid that is a mixture of the hot fluid received at the hot fluid inlet 16 and the colder fluid received at the cold fluid inlet 18, resulting in a discharge fluid having a tempered discharge temperature. The tempered mixed fluid outlet 20 may be fluidly connected to the hot water piping of a building or other structure, and can include a tailpiece fitting 21 or other suitable connector similar to that provided for the hot and cold fluid inlets 16, 18. A fluid flow regulator (not explicitly shown in FIG. 1) may be positioned in the valve body 10 to regulate the relative flow of cold fluid from the cold fluid inlet 18 and hot fluid from the hot fluid inlet 16 to produce the flow of tempered fluid at the outlet 20. The fluid flow regulator may be a thermally controlled fluid regulator, similar to the fluid flow regulator 190 shown and described below with respect to FIG. 4. A pressure reducing element may be formed in the hot fluid inlet upstream of the fluid flow regulator, as will be discussed in more detail with respect to FIG. 2.

In some cases, the mixing valve 2 may also include an optional recirculation inlet 22 configured to receive tempered water from the water piping of the building or other structure, and can include a tailpiece fitting (not shown) or other suitable connector. The recirculation inlet 22 may be used to recirculate water that has previously been delivered to the hot water piping back to the mixing valve 2. The recirculation inlet 22 may be useful in ensuring that hot water at the tempered temperature is immediately available at a desired location within the building, such as in a shower or the like.

The illustrative thermostatic mixing valve 2 also includes an optional secondary hot port 24 for providing hot water directly to an appliance or other fixture that can use non-tempered hot water (e.g. water provided directly from a water heater or the like). For example, the optional secondary hot port 24 may be used to supply non-tempered hot water to a dishwasher, a clothes washer, a humidifier, and/or any other suitable appliance, fixture or device, as desired. The secondary hot port 24 may reduce or eliminate the need for a separate “T” connector off of the water heater source. The secondary hot port 24 can include a tailpiece fitting (not shown) or other suitable connector. The tailpiece fittings may each include a union sweat fitting, threaded fitting (e.g. NPT, NPS, etc.), compression fitting, PEX fitting, and/or any other suitable fitting that can be used to connect the various inlets and outlets of the mixing valve 2 to the other components of the installed system. A threaded coupling (not shown) can be used to secure each of the tailpiece fittings 19, 21 to the valve body 10, if desired.

As can be further seen in FIG. 1, the illustrative thermostatic mixing valve 2 may have a configuration wherein the hot fluid inlet 16 and mixed fluid outlet 20 are vertically and axially aligned along an axis L of the longitudinal portion of valve body 10. This may allow the mixing valve to be mounted “in line” with a water heater hot water outlet pipe, which can simplify installation in some cases. The cold water inlet 18, in turn, may enter the valve body 10 at an angle along axis A, or any angle desired, to the side housing 13. In some embodiments, the cold water inlet 18 may enter the valve body 10 at an angle orthogonal to the longitudinal axis L to permit direct access to the cold water inlet port provided on many conventional water heaters, as described in copending U.S. patent application Ser. No. 12/273,370, filed Nov. 18, 2008, entitled “Thermostatic Mixing Valve with Secondary Hot Port”, which is incorporated by reference.

In the illustrative embodiment of FIG. 1, recirculation inlet 22 is shown entering the valve body 10 at an angle orthogonal to the longitudinal axis L, but in a direction opposite that of the cold water inlet 18. In some cases, recirculation inlet 22 may enter valve body 10 at a different angle. While mixing valve 2 is shown as having recirculation inlet 22, the recirculation inlet 22 is optional and thus may be excluded. Likewise, the secondary hot port 24 may exit the valve body 10 at an angle orthogonal to the longitudinal axis L to permit direct access to the secondary hot port 24. In the illustrative embodiment, the secondary hot port 24 is positioned at a location upstream from a mixing chamber such that non-tempered hot water is available directly from the hot water source. As with the recirculation inlet 22, the secondary hot port 24 is optional and not required.

During operation, the mixing valve 2 can be adjusted to proportionately mix cold and hot water received at each of the water inlets 16,18, which can then be outputted as tempered water at a relatively constant, pre-selected temperature through the mixed water outlet 20. In certain applications, for example, the mixing valve 2 can be configured to output water at a relatively constant or mixed water temperature of about 120° F., while permitting a water heater to operate at elevated temperatures in the range of, for example, about 120° F. to 180° F.

As discussed above, some water heaters may be configured to produce hot water that is at a temperature that is significantly hotter than that desired in the structure's hot water piping. By increasing the temperature of the water supplied by the water heater, a greater amount of cold water may be mixed with the hot water to increase the effective heating capacity of the water heater. Also, some water heaters operate at a higher efficiency when the operating temperature is elevated. For example, in an 80-gallon water heater, such an increase in the operating temperature may result in an increase in the effective hot water capacity that is similar to that of a 120-gallon water heater operating at a lower temperature. It should be understood, however, that the thermostatic mixing valve 2 and/or water heater can be configured to operate at other temperature ranges, as desired.

In the illustrative embodiment of FIG. 1, a temperature adjustment device 12 is disposed within a side housing 13 of the valve body 10, and can be provided to adjust the temperature of tempered fluid discharged from the mixing valve 2. In residential water heating systems, for example, the temperature selection device 12 can be used to adjust the thermostatic mixing valve 2 to output tempered water at a set-point temperature in the range of about 70° F. to 145° F., 70° F. to 120° F., 90° F. to 130° F., or any other temperature range as desired. The set-point temperature selected by the temperature selection device 12 may vary based on the application. In the illustrative embodiment, the temperature adjustment device 12 includes a hand wheel 14 that can be manually turned by a user. However, it is contemplated that the illustrative temperature adjustment device 12 may include any suitable mechanism for adjusting the set-point of the mixing valve 2. When provided, temperature adjustment device 12 may be similar to that described in copending U.S. patent application Ser. No. 12/273,307, filed Nov. 18, 2008, entitled “Thermostatic Mixing Valve with Tamper Resistant Adjustment Feature”, which is incorporated by reference.

FIG. 2 is a partial cross-sectional view of the illustrative thermostatic mixing valve of FIG. 1, showing an illustrative pressure reducing element 15. The fluid flow regulator of the thermostatic mixing valve has been removed for clarity. When not removed, the fluid flow regulator would be situated in the cavity labeled 17. As can be further seen in FIG. 2, the illustrative thermostatic mixing valve 2 has a configuration wherein the hot fluid inlet 16 and tempered or mixed fluid outlet 20 are vertically and axially aligned along an axis of the longitudinal portion of valve body 10, but this is not required. This may allow the mixing valve to be mounted “in line” with a water heater hot water outlet pipe, which can simplify installation in some cases. The cold water inlet (not shown in FIG. 2), in turn, may enter the valve body 10 at an angle orthogonal to the longitudinal axis “L” (see FIG. 1) to permit direct access to the cold water inlet port provided on many conventional water heaters.

The illustrative thermostatic mixing valve 2 also includes a pressure reducing element 15 that is situated in the hot fluid inlet port 16 upstream of chamber 17, which if shown, would house the fluid flow regulator. The pressure reducing element 15 may include, for example, a pressure reduction disk or snubber element 15 that defines an aperture with a cross-sectional area, such as an aperture with a diameter “D”. In some embodiments, pressure reducing element 15 may be integrally formed with the valve housing 10. In other embodiments, the pressure reducing element 15 may be a separate component that is fitted in the hot fluid port 16. In some embodiments, hot fluid inlet port 16 may have a first cross-sectional area upstream of the pressure reducing element 15. The first cross-sectional area of the hot fluid inlet port 16 may be greater than the cross-sectional area of the aperture of the pressure reducing element 15. In some cases, the cross-sectional area of the hot fluid inlet port 16 may be configured to facilitate connection with a hot fluid supply. In some cases, the pressure reducing element 15 may be situated a distance downstream of the entry of the hot fluid inlet port 16, and downstream of the mixing chamber 17 as shown in FIG. 2.

Pressure reducing element 15 may define an aperture having a cross-sectional area that is smaller than the cross-sectional area of hot fluid inlet port 16. In some instances, the cross-sectional area of the aperture of the pressure reducing element 15, illustrated by diameter D in FIG. 2, may be 80% or less, 60% or less, 40% or less, or 20% or less, of the cross-sectional area of the hot fluid inlet port 16 upstream of the pressure reducing element 15. In the illustrative embodiment, the diameter D of the aperture of the pressure reducing element 15 may be set to any suitable value, depending on the desired flow rate through the mixing valve 2. For example, the diameter D may be smaller than 0.10 inches, 0.10 inches, 0.20 inches, 0.30 inches, 0.4 inches or larger depending on the application. In one example, the cross-sectional area of the hot fluid inlet port 16 upstream of the pressure reducing element 15 may be greater than about 0.12 inches square, and the cross-sectional area of the aperture at the pressure reducing element 15 may be less than about 0.07 inches square. In another example, the cross-sectional area of the hot fluid inlet port 16 upstream of the pressure reducing element 15 may be greater than about 0.19 inches square, and the cross-sectional area of the aperture at the pressure reducing element 15 may be less than about 0.13 inches square.

In yet another example, the cold fluid inlet 18 (see FIG. 1) of the thermostatic mixing valve 10 may be dimensioned to pass a first flow rate of cold fluid when the cold fluid is presented to the thermostatic mixing valve at a first pressure. The hot fluid inlet 16 of the thermostatic mixing valve 10 may be dimensioned to pass a second flow rate of hot fluid when the hot fluid is presented to the thermostatic mixing valve at the same first pressure. In some cases, the second flow rate is less than 80% of the first flow rate, sometimes due to the presence of a pressure reducing element 15 or some other feature of the hot fluid inlet 16 and no equivalent feature in the cold fluid inlet. In other cases, the second flow rate may be less than 60%, less than 40%, less than 20% or even less than the first flow rate, depending on the application.

While the aperture in pressure reducing element 15 of FIG. 2 is illustrated as a circular aperture, it is contemplated the aperture may be of any suitable shape including, for example, square, elliptical, rectangular, or polygonal. In some embodiments, pressure reducing element 15 may be formed of brass, however, it is contemplated that the pressure reducing element 15 may be formed of any suitable material or material combination as desired, such as, but not limited to other metals, metal alloys, elastomers, and/or plastics. The material of the pressure reducing element 15 may be selected in accordance with the environment in which the valve may be used.

The illustrative mixing valve 2 of FIG. 2 may also include an optional secondary hot port 24 for providing hot water directly to an appliance or other fixture that can use non-tempered hot water (e.g. water provided directly from a water heater or the like). As can be seen in FIG. 2, the secondary hot port 24 may be disposed at a location upstream of the mixing chamber 17 such that non-tempered water may be available directly from the mixing valve 2. In some cases, such an optional secondary hot port 24 may be used to supply non-tempered hot water to a dishwasher, a clothes washer, a humidifier, and/or any other suitable appliance, fixture or device, as desired. The secondary hot port 24 may reduce or eliminate the need for a separate “T” connector off of the water heater source.

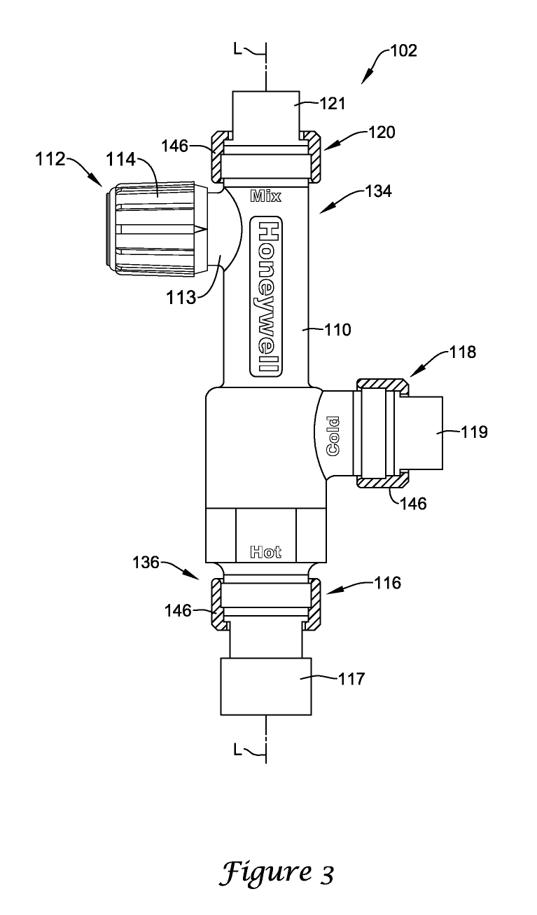

FIG. 3 is a front elevation view, with parts in cross-section, of another illustrative thermostatic mixing valve. While the configuration of mixing valve 102 in FIG. 3 is somewhat different from that of mixing valve 2 of FIGS. 1-2, its general function is similar. Similar to that discussed above with respect to FIG. 1, mixing valve 102 of FIG. 3 has a hot fluid inlet 116, a cold fluid inlet 118, and a mixed fluid outlet 120. The hot fluid inlet 116, cold fluid inlet 118, and mixed fluid outlet 120 can each include a tailpiece fitting 117,119,121 or other suitable connector for connecting the inlet ports 116,118,120 to a water system. For example, threaded couplings 146 can be used to secure each of the tailpiece fittings 117,119,121 to the valve body 110, but this is not required. It is contemplated that the mixing valve 102 may also include an optional recirculation inlet (not shown) configured to receive tempered water, and can include an associated tailpiece fitting (not shown) or other suitable connector. Similar to the embodiment shown in FIG. 1, mixing valve 102 may include an optional secondary hot port (not shown) for providing hot water to appliances or other fixtures that do not require tempered hot water, such as but not limited to dishwashers, clothes dryers, humidifiers, etc.

As can be further seen in FIG. 3, the mixing valve 102 may have a vertical, in-line configuration wherein the hot fluid inlet 116 and mixed fluid outlet 120 are vertically and axially aligned along an axis L of the valve body 110. As discussed above, this may allow the mixing valve to be mounted “in line” with a water heater hot water outlet pipe, which can simplify installation. As shown, the cold water inlet 118, in turn, may enter the valve body 110 at an angle orthogonal to the longitudinal axis L to permit direct access to the cold water inlet port provided on many conventional water heaters. The recirculation inlet, when provided, may enter the valve body 110 at an angle orthogonal to the longitudinal axis L, but in a direction opposite that of the cold water inlet 118, or any other desired location. The secondary hot port, when provided, may exit the valve body 110 at an angle orthogonal to the longitudinal axis L to permit direct access to the secondary hot port, but this is not required. While an in-line configuration is shown in FIGS. 1 and 3, it is contemplated that the mixing valve may have any suitable configuration including a “T” configuration or any other suitable configuration as desired. In a “T” configuration, a hot fluid inlet and a cold fluid inlet may enter the valve body from left and right sides, respectively, and a mixed fluid outlet may exit the valve body in a downward direction. This is just another example configuration that may be used.

Similar to the embodiment described in FIG. 1, during operation, the mixing valve 102 can be adjusted to proportionately mix hot and cold water received at each of the water inlets 116,118, in order to provide tempered water at a relative constant temperature through mixed water outlet 120. As previously discussed, in certain applications, for example, the mixing valve 102 can be configured to output water at a relatively constant mixed water temperature of about 120° F., while permitting a water heater to operate at elevated temperatures in the range of, for example, about 120° F. to 180° F. It should be understood, however, that the mixing valve 102 and/or water heater can be configured to operate at other temperature ranges, if desired.

As shown in FIG. 3, a temperature adjustment device 112 may be disposed within a side housing 113 of the valve body 110. The temperature adjustment device 112 can be used to adjust the temperature of fluid discharged from the mixed fluid outlet 120 of the mixing valve 102. In residential water heating systems, for example, the temperature adjustment device 112 can be used to adjust the mixing valve 102 to output tempered water at a set-point temperature in the range of about 70° F. to 145° F., 70° F. to 120° F., 90° F. to 130° F., or within any other suitable range, as desired. The set-point temperature selected by the temperature adjustment device 112 may vary depending on the application. In the illustrative embodiment, the temperature adjustment device 112 may include a hand wheel 114 for adjusting the set-point of the mixing valve 102.

FIG. 4 is a cross-sectional view of the illustrative thermostatic mixing valve of FIG. 3 shown an illustrative a pressure reducing element 115. As shown in FIG. 4, the hot fluid inlet 116 of the valve body 110 may include gasket 108 adapted to frictionally secure a tailpiece fitting 117 to the valve body 110. The tailpiece fitting 117, in turn, can be secured to the valve body 110 using a threaded coupling 146. Such a configuration may permit the tailpiece fitting 117 to be separately connected to a pipe or a conduit supplying hot water from a water heater or the like, and attached thereto using the threaded coupling 146. A similar arrangement can be provided for connecting tailpiece fittings to the cold fluid inlet 118 and mixed fluid outlet 120, if desired.

The illustrative mixing valve 102 also includes a pressure reducing element 115. Pressure reducing element 115 may be an annular pressure reduction disk defining an aperture with a diameter D1 disposed in the hot fluid inlet port 116. In some embodiments, pressure reducing element 115 may be integrally formed with the valve housing 110. In other embodiments, the pressure reducing element may be a separate component press fit or otherwise provided in the hot fluid port 116. In some embodiments, hot fluid inlet port 116 may have a first cross-sectional area different from the cross-sectional area defined by the aperture in pressure reducing element 115. In some cases, the cross-sectional area of the hot fluid inlet port 116 upstream of the pressure reducing element 115 may be configured to more easily connect to a hot fluid supply pipe. Pressure reducing element 115 may be positioned a distance downstream from the entry of the hot fluid inlet port 116, but upstream of a fluid flow regulator 190.

Pressure reducing element 115 may define an aperture having a cross-sectional area (illustrated by diameter D1 in FIG. 4) that is less than the cross-sectional area of hot fluid inlet port 116 upstream of the pressure reducing element 115. In some instances, the cross-sectional area of the aperture of the pressure reducing element 115 may be 80% or less, 60% or less, 40% or less, or 20% or less, of the cross-sectional area of the hot fluid inlet port 116 and/or the cold fluid inlet port 118. The cross-sectional area of the aperture of the pressure reducing element 115 may be set depending on the desired flow rate through the mixing valve 102. For example, in the illustrative embodiment of FIG. 4, the diameter D1 of the pressure reducing element 115 may be smaller than 0.10 inches, 0.10 inches, 0.20 inches, 0.30 inches, 0.4 inches, or larger depending on the application. In one example, the cross-sectional area of the hot fluid inlet port 116 upstream of the pressure reducing element 115 may be greater than about 0.12 inches square, and the cross-sectional area of the aperture at the pressure reducing element 115 may be less than about 0.07 inches square. In another example, the cross-sectional area of the hot fluid inlet port 116 upstream of the pressure reducing element 115 may be greater than about 0.19 inches square, and the cross-sectional area of the aperture at the pressure reducing element 115 may be less than about 0.13 inches square.

In yet another example, the cold fluid inlet 118 of the thermostatic mixing valve 102 may be dimensioned to pass a first flow rate of cold fluid when the cold fluid is presented to the thermostatic mixing valve at a first pressure. The hot fluid inlet 116 of the thermostatic mixing valve 102 may be dimensioned to pass a second flow rate of hot fluid when the hot fluid is presented to the thermostatic mixing valve at the same first pressure. In some cases, the second flow rate is less than 80% of the first flow rate, sometimes due to the presence of a pressure reducing element 115 or some other feature of the hot fluid inlet 116 and no equivalent feature in the cold fluid inlet 118. In other cases, the second flow rate may be less than 60%, less than 40%, less than 20% or even less than the first flow rate, depending on the application.

While the aperture in pressure reducing element 115 of FIG. 4 is illustrated as a circular aperture, it is contemplated the aperture may be of any suitable shape including, for example, square, elliptical, rectangular, or polygonal. In some embodiments, pressure reducing element 115 may be formed of brass, however, it is contemplated that the pressure reducing element 115 may be formed of any suitable material or material combination as desired, such as, but not limited to other metals, metal alloys, and/or plastics. The material of the pressure reducing element 115 may be selected in accordance with the environment in which the valve may be used.

The fluid flow regulator 190 of FIG. 4 thermostatically adjusts the flow of cold and hot fluid injected into a mixing chamber 160 of the valve body 110. In the illustrative embodiment, the fluid flow regulator 190 includes a spool 162, a modulating spring 164, a piston stem 166, a bypass spring 168, a diffuser 170, and a temperature sensitive (e.g. wax filled) thermal element 172. The spool 162 may be movably disposed between a first inner surface 174 of valve body 110 and a second inner surface 176 of the valve body 110 in a direction substantially aligned with the general longitudinal axis L (see FIG. 3). The distance between the first inner surface 174 of the valve body 110 and the second inner surface 176 thereof is referred to as the spool stroke, and is typically greater than the overall axial length of the spool 162 to permit the spool 162 to travel up and down within the interior of the valve body 110. An O-ring 178 can be provided to frictionally support the spool 162 within the valve body 110 as the spool 162 is actuated between the first and second inner surfaces 174,176. In some embodiments, the spool 162, valve body 110 as well as other internal components of the mixing valve 102 can be coated with a layer of Teflon® or other suitable lubricous material to facilitate movement of the spool 162 within the valve body 110 and/or to prevent mineral buildup from occurring within the mixing valve 102, but this is not required.

The spring 164 can be used to bias the spool 162 towards the first inner surface 174 of the valve body 110, and can be operatively coupled at a first (i.e. upper) end to a hub 180 which is coupled to the lower end of the piston stem 166, and at a second (i.e. lower) end to a portion 182 of the end cap 184. The bypass spring 168 can be provided to further load the spool 162 and spring 164. The spring 164 and bypass spring 168 can be operatively coupled to the piston stem 166, which can be configured to move within the valve body 110 as a result of the axial expansion and contraction of the thermal element 172 in response to the temperature of fluid contained within the mixing chamber 160.

A diffuser 170 may be configured to help mix or blend hot and cold fluid contained within the mixing chamber 160 prior to passing upwardly beyond the thermal element 172 and out the mixed fluid outlet 120. The diffuser 170 may be formed as a separate element from the piston stem 166 or can be formed integral therewith from a single piece of material. In certain embodiments, for example, the piston stem 166 and diffuser 170 can be formed from a single composite piece of polypropylene loaded with fiberglass, although other configurations are contemplated.

The temperature adjustment device 112 may include an adjustment mechanism that is rotatably disposed within the side housing 113 of the valve body 110. In certain embodiments, the adjustment mechanism may include an adjusting screw 130, a collar 148, an O-ring 156, and a spring element 128 disposed within a hand wheel 114, allowing the user to adjust the temperature or set-point of the fluid discharged from the mixed fluid outlet 120 of the mixing valve 102 without any special tools, yet help prevent accidental adjustment of the output mixed temperature.

The hand wheel 114 may have a first engagement surface 154 while the adjusting screw 130 may have a second engagement surface 132. In the illustrative embodiment shown, the center support 154 may extend orthogonally outward from an internal surface 123 of the hand wheel 114, and may include a hole or recess extending therethrough. The first engagement surface 154 may be formed or otherwise disposed on the internal surface of the hole or recess of the center support 154 as shown, and may be formed as gear-like teeth. In FIG. 4, the hand wheel 114 is movable in an axial direction toward the adjusting screw 130, and rotatable relative to the attachment screw 130.

Hand wheel 114 is shown in a non-temperature adjusting position in FIG. 4. When in the non-temperature adjusting position, the first engagement surface 154 is disengaged from the second engagement surface 132. As such, the hand wheel 114 can be rotated without causing rotation of the adjusting screw 130. Since the adjusting screw 130 is not rotated, the output temperature of the mixing valve 102 is not manipulated. This may help prevent accidental and/or unintentional manipulation of the output temperature of the mixing valve 102 by a user. Spring 128 biases the hand wheel 114 into the non-temperature adjusting position.

In the illustrative embodiment, the temperature of the fluid exiting the mixed outlet port 120 of the mixing valve 120 may be adjusted by moving the hand wheel 114 axially towards the valve body 110, overcoming the bias of the spring 128, to a temperature adjusting position. When in the temperature adjusting position, the first engagement surface 154 may become engaged with the second engagement surface 132. Once engaged, the hand wheel 114 may be turned in a clockwise or counterclockwise direction resulting in the rotation of the adjusting screw 130. In the illustrative embodiment, this causes the adjusting screw 130 to move axially along axis 131 in a direction that corresponds to the direction that the hand wheel 114 was turned. The O-ring 156 disposed within the interior of the side housing 113 can be configured to provide a fluidic seal for the adjustment screw 130 while permitting axial movement of the adjusting screw 130 along the axis 131.

In the illustrative embodiment, a collar 196 movably disposed within the mixing chamber 160 in a direction axially along the longitudinal axis L of the valve body 110, is configured to engage the fluid flow regulator 190 for adjusting the nominal positioning of the spool 162 within the valve body 110. The nominal position of the spool 162 within the valve body defines the “set-point” of the mixing valve 102. The illustrative collar 196 defines an angled surface 199 that is adapted to engage a tapered section 106 of the adjusting screw 130. During use, the temperature selection device 112 is operable by moving the hand wheel 114 axially along axis 131 until the first engagement surface 154 engages the second engagement surface 132. The hand wheel 114 is then turned in either a clockwise or counterclockwise direction, causing the adjusting screw 130 and adjusting stem 152 to move axially along axis 131. As the adjusting screw 130 moves, the tapered section 106 of the adjusting screw 130 moves the collar 196 and thus the nominal position of the spool 162 in either an upward or downward direction, respectively, within the valve body 110.

Rotation of the adjustment screw 130 in a clockwise direction, for example, causes the tapered section 106 to push the collar 196 and thus the nominal position of the spool 162 in a downward direction within the valve body 110. This increases the amount of compression within the spring 164 and moves the spool 162 further towards the second inner surface 176 of the valve body 110. Conversely, rotation of the adjustment screw 130 in a counterclockwise direction causes the tapered section 106 to move the collar 196 and thus the nominal position of the spool 162 in an upward direction within the valve body 110. This decreases the amount of compression within the spring 164 and moves the spool 162 towards the first inner surface 174 of the valve body 110. Such adjustment of the distance of the spool 162 between the first and second inner surfaces 174,176 results in a nominal change in the ratio of hot and cold water mixed within the mixing valve 110, resulting in a change in the “set-point” temperature of fluid discharged from the mixing valve 102.

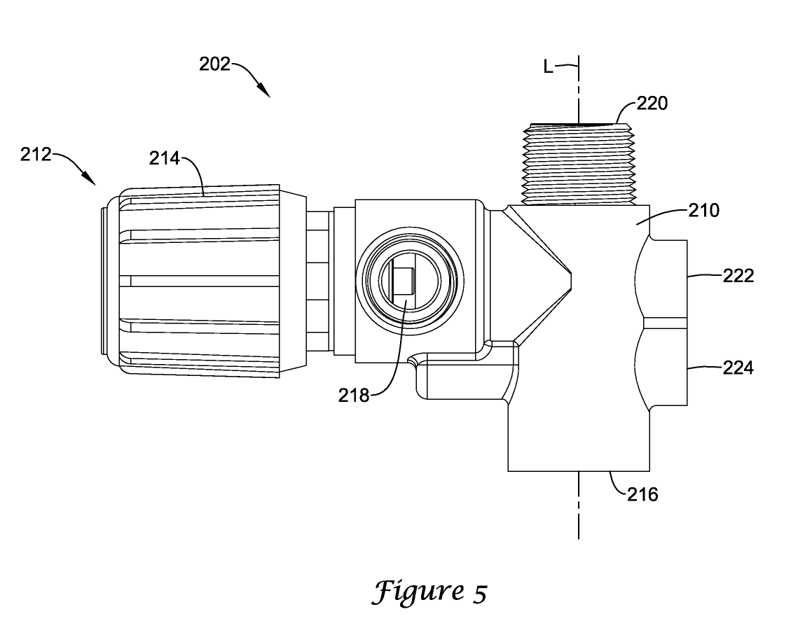

FIG. 5 is a side view of another illustrative thermostatic mixing valve 202 with a secondary hot port. While the configuration of mixing valve 202 is slightly different from that of mixing valves 2 and 102, the general function of mixing valve 202 is similar to that of valves 2 and 102. As discussed above with respect to FIGS. 1 and 3, mixing valve 202 may have a hot fluid inlet 216, a cold fluid inlet 218, and a mixed fluid outlet 220. The hot fluid inlet 216, cold fluid inlet 218, and mixed fluid outlet can each include a tailpiece fitting or other suitable connector for connecting the ports 216,218,220 to the water piping within a building or other structure.

As shown, the illustrative mixing valve 202 may include an optional recirculation inlet 222 configured to receive tempered water, and can include a tailpiece fitting (not shown) or other suitable connector if desired. Similar to the embodiment shown in FIG. 1, mixing valve 202 may include an optional secondary hot port 224 for providing hot water to appliances or other fixtures that do not require tempered hot water, such as but not limited to dishwashers, clothes washers, humidifiers, etc. The secondary hot port 224 can include a tailpiece fitting (not shown) or other suitable connector, if desired. The tailpiece fittings may each include a union sweat fitting, threaded fitting (e.g. NPT, NPS, etc.), compression fitting, PEX fittings, and/or any other suitable fittings for connecting the various inlets and outlets of the mixing valve 202 to the other components of the system. A threaded coupling (not shown) can be used to secure each of the tailpiece fittings to the valve body 210, if desired.

As can be seen in FIG. 5, the mixing valve 202 may have a configuration whereby the hot fluid inlet 216 and mixed fluid outlet 220 are vertically and axially aligned along an axis L of the valve body 210. This may allow the mixing valve 202 to be mounted “in line” with a water heater hot water outlet pipe, which can simplify installation. The cold water inlet 218, in turn, may enter the valve body 210 at an angle orthogonal to the longitudinal axis L to permit direct access to the cold water inlet port provided on many conventional water heaters. In the illustrative embodiment of FIG. 5, recirculation inlet 222 is shown entering the valve body 210 at an angle orthogonal to the longitudinal axis L, but in a direction perpendicular to that of the cold water inlet 218. In some cases, recirculation inlet 222 may enter valve body 210 at a different angle, if desired. While mixing valve 202 is shown as having recirculation inlet 222, the recirculation inlet 322 is optional and thus may be excluded. Likewise, the secondary hot port 224 may exit the valve body 210 at an angle orthogonal to the longitudinal axis L to permit direct access to the secondary hot port 224. In the illustrative embodiment, the secondary hot port 224 is positioned at a location upstream from a mixing chamber such that non-tempered hot water is available directly from the hot water source. As with the recirculation inlet 322, the secondary hot port 224 is optional and not required.

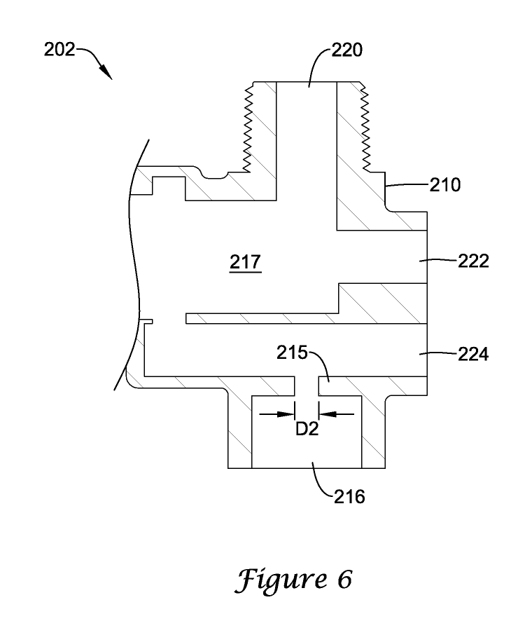

It is contemplated that a pressure reducing element may be inserted or otherwise provided in the hot fluid inlet 216 of the mixing valve 202 upstream of a fluid flow regulator, as shown in FIG. 6. Like FIG. 2, the fluid flow regulator of the mixing valve 202 has been removed for clarity, but would be positioned in cavity 217 if shown. As can be further seen in FIG. 6, the mixing valve 202 may have a configuration wherein the hot fluid inlet 316 and mixed fluid outlet 220 are vertically and axially aligned along an axis of the longitudinal portion of valve body 210. This may allow the mixing valve to be mounted “in line” with a water heater hot water outlet pipe, which can simplify installation. The cold water inlet (not shown), in turn, may enter the valve body 210 at an angle orthogonal to the longitudinal axis to permit direct access to the cold water inlet port provided on many conventional water heaters.

As shown, the mixing valve 202 may include a pressure reducing element 215. In some cases, pressure reducing element 215 may be an annular pressure reduction disk 15 defining an aperture with a diameter D2 disposed in the hot fluid inlet port 216. In some embodiments, pressure reducing element 215 may be integrally formed with the valve housing 210. In other embodiments, the pressure reducing element may be a separate component press fit or otherwise provided in the hot fluid port 216. In some embodiments, hot fluid inlet port 216 may have a first cross-sectional area different from the cross-sectional area defined by the aperture in pressure reducing element 215. The cross-sectional area of the hot fluid inlet port 216 may be configured to connect with a hot fluid supply. In some cases, pressure reducing element 215 may be positioned a distance downstream from the hot fluid inlet port, and upstream from the chamber 217 which would house the fluid flow regulator if shown. It is contemplated that pressure reducing element 215 may be positioned anywhere upstream of the fluid flow regulator.

In some instances, pressure reducing element 215 may define an aperture having a cross-sectional area (illustrated by diameter D2) that is less than the cross-sectional area of hot fluid inlet port. In some instances, the cross-sectional area, illustrated by diameter D2, may be 80% or less, 60% or less, 40% or less, or 20% or less, of the cross-sectional area of the hot fluid inlet port 216. The diameter D2 of the aperture in pressure reducing element 215 may be set depending on the desired flow rate through the mixing valve 202. For example, the diameter D2 may be smaller than 0.10 inches, 0.10 inches, 0.20 inches, 0.30 inches, 0.4 inches or larger depending on the application. While the aperture in pressure reducing element 215 is illustrated as a circular aperture, it is contemplated the opening may be of any suitable shape including, for example, square, elliptical, rectangular, or polygonal. In some embodiments, pressure reducing element 215 may be formed of brass, however, it is contemplated that the pressure reducing element 215 may be of any material desired, such as, but not limited to other metals, metal alloys, and/or plastics. The material of the pressure reducing element 215 may be selected in accordance with the environment in which the valve may be used.

The illustrative mixing valve 202 may include an optional secondary hot port 224 for providing hot water directly to an appliance or other fixture that can use non-tempered hot water (e.g. water provided directly from a water heater or the like). As can be seen in FIG. 6, the secondary hot port 224 may be disposed at a location upstream of chamber 217 such that non-tempered water may be available directly from the mixing valve 202. For example, the optional secondary hot port 224 may be used to supply non-tempered hot water to a dishwasher, a clothes washer, a humidifier, and/or any other suitable appliance, fixture or device, as desired. The secondary hot port 224 may reduce or eliminate the need for a separate “T” connector off of the water heater source.

In some embodiments, the mixing valve 202 may include an optional recirculation inlet 222 in fluid communication with a return pipe or conduit that can be used to recirculate tempered water discharged from the mixed water outlet 220 back into the mixing valve 202. In use, the ability to recirculate water through the mixing valve 202 may help prevent cold water from building up within the mixed water pipe or conduit during periods of nonuse, or when the demand for mixed water is low. Such recirculation feature within the mixing valve 202 can also be used to overcome the characteristic of many thermostatic mixing valves to overshoot the desired mixing temperature after relatively long periods of nonuse (e.g. overnight) or shortly after a previous draw.

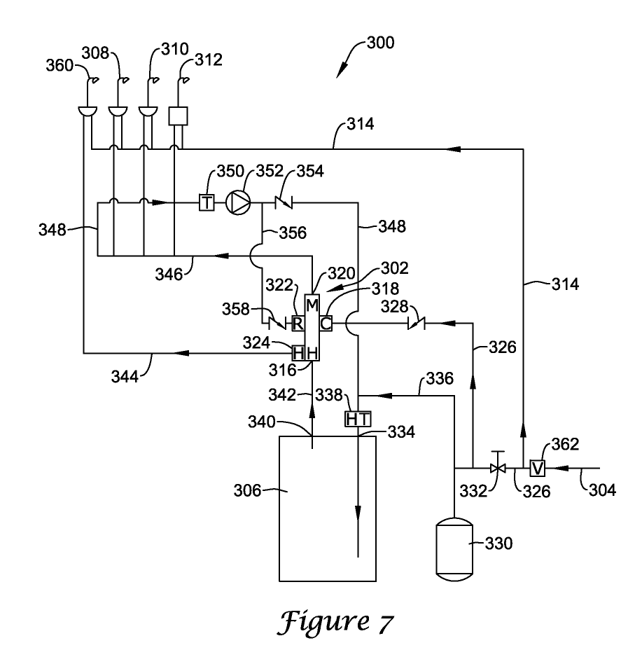

FIG. 7 is a schematic view showing an illustrative but non-limiting water heater system 300 employing a thermostatic mixing valve 302 that may be similar to the thermostatic mixing valves 2, 102, and/or 202 described above. As shown in FIG. 7, thermostatic mixing valve 302 may be installed within a water heater system 300 having a cold water supply 304, a water heater 306, and a number of fixture units 308,310,312,360, in fluid communication with the mixing valve 302, cold water supply 304, and a water heater 306. Water heater system 300 may represent, for example, a residential water heater system adapted to deliver hot water to a number of fixture units such as a shower, bath, lavatory, faucet, clothes washer, dishwasher, or other such device wherein the delivery of tempered hot water is desired.

Cold water supplied by the cold water supply 304 can be delivered through a first pipe or conduit 314 for delivery directly to each of the fixture units 308,310,312,360 within the system 300. A second pipe or conduit 326 in fluid communication with a cold water inlet 318 of the mixing valve 302 and a check-valve 328, in turn, may be used to supply cold water to the mixing valve 302, which can be mixed with hot water discharged from the water heater 306. A backflow preventer, check valve, pressure reducing valve, or other suitable mechanism 362 for controlling backflow at the inlet of the cold water supply 304 can be provided to make the system 300 a closed system, if desired. In such embodiments, an expansion tank 430 can be provided in fluid communication with the water heater 306 to relieve any excess pressure within the water heater 306 and/or to prevent the discharge of water from the safety relief valve provided on many water heaters. A shut-off valve 332 can also be provided along the pipe or conduit 326 to permit the user to shut-off the supply of water delivered to the mixing valve 302 and/or water heater 306, if desired.

An inlet port 334 of the water heater 306 can be configured to receive cold water via a water heater inlet pipe 336 in fluid communication with pipe or conduit 326. If desired, the inlet port 334 of the water heater 306 can be equipped with an optional heat trap 338 for reducing convection currents at the inlet port 334 of the water heater 306 that can cause thermo-siphoning of heat from the water heater 306.

An outlet port 340 of the water heater 306 can be configured to deliver hot water through pipe or conduit 342 and into a hot water inlet 316 of the mixing valve 302. The outlet port 340 of the water heater 306 will typically be located close to the hot water inlet 316 of the mixing valve 302 (e.g. ≦1 ft) to reduce head and thermal losses through pipe or conduit 342. In certain embodiments, for example, the hot water inlet 316 of the mixing valve 302 can be coupled directly to the outlet port 340 of the water heater 306 using a threaded pipe fitting, union sweat connection, or other suitable connector. If desired, a diverter pipe 344 in fluid communication with a secondary hot port 324 on the mixing valve can be provided to divert some of the hot water discharged from the water heater 306 to other fixtures 360 within the system 300 (e.g. a dishwasher, clothes washer, humidifier, etc.) where temperature regulation via the mixing valve 302 may be undesired.

During operation, the mixing valve 302 can be configured to proportionately mix cold and hot water received at each of the water inlets 318,316, which can then be outputted as tempered water at a relatively constant, pre-selected temperature through a mixed water outlet 320 and hot water piping or conduit 346 in fluid communication with each of the fixture units 304,405,306 that require tempered water. In certain applications, for example, the mixing valve 302 can be configured to output water at a relatively constant mixed water temperature of about 120° F. while permitting the water heater 306 to operate at elevated temperatures in the range of, for example, about 120° F. to 180° F. Such an increase in the operating temperature of the water heater 306 can result in an increased amount of effective hot water capacity available for use. For an 80-gallon water heater, for example, such an increase in the operating temperature may result in an increase in the effective hot water capacity to a level similar to that of a 120-gallon water heater operating at a lower temperature of 120° F. It should be understood, however, that the mixing valve 302 and/or water heater 306 can be configured to operate at other temperatures and/or temperature ranges, if desired.

While the illustrative mixing valve 302 of FIG. 7 is shown installed within a water heater system, it should be understood that the mixing valve 302 could be used in any number of applications wherein the control and regulation of fluids of dissimilar temperature is desired.

Examples of other applications may include, but are not limited to, space and radiant heating applications, heat pump systems, hydronic heating applications, combination heating applications, industrial heating applications, photo processing applications, nursing home applications, greenhouse applications, and/or solar hot water applications. Moreover, in some embodiments such as space heating applications, for example, the mixing valve 302 can be configured to function as a diverting valve to permit the diversion of hot or cold water to particular fixtures within the system, if desired.

In the illustrative embodiment, the thermostatic mixing valve 302 is equipped with an optional recirculation inlet 322. A recirculation pipe or conduit 348 in fluid communication with pipe or conduit 346 can be provided to permit the recirculation of mixed water back into the inlet port 334 of the water heater 306. A thermostat 350 and pump 352 operatively coupled to the recirculation pipe or conduit 348 downstream of the fixture units 304,305,306 can be provided to intermittently draw fluid back into the water heater 306, as needed. The thermostat 350 can be set to ensure that the temperature within the recirculation pipe or conduit 348 remains at a certain temperature or range of temperatures, turning on the recirculation pump 352 periodically when the temperature therein reaches a certain minimum threshold temperature. If, desired, a check valve 354 installed downstream of the pump 352 can be provided to prevent the backflow of water into the pump 352.

The mixing valve 302 may also include a recirculation inlet 322 in fluid communication with a return pipe or conduit 356 that can be used to recirculate tempered water discharged from the mixed water outlet 320 back into the mixing valve 302. The return pipe or conduit 356 can be connected to the recirculation pipe or conduit 348 at a location downstream of the pump 352, and can include a check valve 358 to prevent the backflow of water from the mixing valve 302 into the return pipe or conduit 356. In use, the ability to recirculate water through the mixing valve 302 may help prevent cold water from building up within the mixed water pipe or conduit 346 during periods of nonuse, or when the demand for mixed water is low. Such recirculation feature within the mixing valve 302 can also be used to overcome the characteristic of many thermostatic mixing valves to overshoot the desired mixing temperature after relatively long periods of nonuse (e.g. overnight) or shortly after a previous draw.

### EXAMPLES

A series of experiments were designed and performed to optimize the pressure drop across the pressure reducing element and temperature stability of the mixed fluid outlet. Tests varying the diameter (e.g. D, D1, D2) of the aperture of a pressure reducing element inserted into the hot fluid inlet of a mixing valve upstream of the fluid flow regulator were run with four different setups. The parameters for each setup are summarized in Table 1 below:

TABLE 1
Experimental Parameters

| Setup | Flow | Hot Fluid | Cold Fluid |
|---|---|---|---|
| Name | Rate (GPM) | Temperature In (° F.) | Temperature In (° F.) |
| A | 8 | 140 | 43 |
| B | 4 | 140 | 43 |
| C | 4 | 165 | 43 |
| D | 8 | 165 | 43 |

Setups A-D were each run for each “Aperture Diameter” set forth below. The mixed fluid temperature for each run was measured with a target temperature of 110° F. The results are summarized in Table 2 below:

TABLE 2
Experimental Results

| | |
|---|---|
| Aperture | Mixed Temperature Output (° F.) |

| Diameter (inches) | Setup A | Setup B | Setup C | Setup D |
|---|---|---|---|---|
| 0.5* | 110 | 113 | 120 | 116 |
| 0.4 | 110 | 113 | 125 | 115 |
| 0.38 | 110 | 110 | 118 | 117 |
| 0.26 | 110 | 112 | 117 | 110 |
| 0.25 | 110 | 111 | 115 | 111 |
| 0.22 | 110 | 111 | 115 | 110 |
| 0.2 | 110 | 111 | 112 | 110 |

*No pressure reducing element was present, 0.5″ was the equivalent of the pipe diameter.

As can been in Table 2, decreasing the diameter of the pressure reducing element from 0.5 inches to 0.2 inches increased the temperature stability substantially. That is, a diameter of 0.5 inches resulted in the Mixed Temperature Output of the mixing valve to range from 110 to 120 degrees across all four setups A-D, which represents about a 9% temperature variation. In contrast, providing a pressure reducing element with an aperture diameter of 0.2 inches resulted in the Mixed Temperature Output of the mixing valve to range from 110 to 112 degrees across all four setups A-D, which represents about a 1.8% temperature variation. As can be seen, the temperature stability of the Mixed Temperature Output is substantially improved, given variations in the temperature and/or pressure of the hot and/or cold fluids presented at the hot fluid inlet and the cold fluid inlet of the valve.

What is claimed is:

1. A thermostatic mixing valve, comprising:
a cold fluid inlet for passing a flow of cold fluid;
a hot fluid inlet for passing a flow of hot fluid;
an outlet for passing a flow of tempered fluid;
a fluid flow regulator in fluid communication with the cold fluid inlet and the hot fluid inlet, the fluid flow regulator configured to regulate the relative flow of cold fluid from the cold fluid inlet and hot fluid from the hot fluid inlet to produce the flow of tempered fluid through the outlet; and
a pressure reducing element situated in the hot fluid inlet upstream of the fluid flow regulator, wherein the cross-sectional area of the hot fluid inlet upstream of the pressure reducing element is greater than the cross-sectional area at the pressure reducing element.

2. The thermostatic mixing valve of claim 1, wherein the cross-sectional area of the hot fluid inlet upstream at the pressure reducing element is less than 80% of the cross-sectional area of the hot fluid inlet upstream of the pressure reducing element.

3. The thermostatic mixing valve of claim 1, wherein the cross-sectional area of the hot fluid inlet upstream at the pressure reducing element is less than 80% of the cross-sectional area of the hot fluid inlet upstream of the pressure reducing element.

4. The thermostatic mixing valve of claim 1, wherein the cross-sectional area of the hot fluid inlet upstream at the pressure reducing element is less than 60% of the cross-sectional area of the hot fluid inlet upstream of the pressure reducing element.

5. The thermostatic mixing valve of claim 1, wherein the cross-sectional area of the hot fluid inlet upstream at the pressure reducing element is less than 40% of the cross-sectional area of the hot fluid inlet upstream of the pressure reducing element.

6. The thermostatic mixing valve of claim 1, wherein the cross-sectional area of the hot fluid inlet upstream of the pressure reducing element is greater than about 0.12 inches square, and the cross-sectional area at the pressure reducing element is less than about 0.07 inches square.

7. The thermostatic mixing valve of claim 1, wherein the cross-sectional area of the hot fluid inlet upstream of the pressure reducing element is greater than about 0.19 inches square, and the cross-sectional area at the pressure reducing element is less than about 0.13 inches square.

8. The thermostatic mixing valve of claim 1, wherein the thermostatic mixing valve includes a valve body that integrally forms the cold fluid inlet, the hot fluid inlet, the outlet and the pressure reducing element.

9. The thermostatic mixing valve of claim 1, wherein the thermostatic mixing valve includes a valve body that integrally forms the cold fluid inlet, the hot fluid inlet, and the outlet, and the pressure reducing element is formed separately and inserted into the hot fluid inlet.

10. The thermostatic mixing valve of claim 1, wherein the cross-sectional area of the hot fluid inlet at the pressure reducing element is annular in shape.

11. A thermostatic mixing valve, comprising:
a cold fluid inlet dimensioned to pass a first flow rate of cold fluid when the cold fluid is presented to the thermostatic mixing valve at a first pressure;
a hot fluid inlet dimensioned to pass a second flow rate of hot fluid when the hot fluid is presented to the thermostatic mixing valve at the first pressure, the second flow rate being less than 80% of the first flow rate;
an outlet for passing a flow of tempered fluid;
a fluid flow regulator in fluid communication with the cold fluid inlet and the hot fluid inlet, the fluid flow regulator configured to regulate the relative flow of cold fluid from the cold fluid inlet and hot fluid from the hot fluid inlet to produce the flow of tempered fluid through the outlet.

12. The thermostatic mixing valve of claim 11, wherein the second flow rate being less than 60% of the first flow rate.

13. The thermostatic mixing valve of claim 11, wherein the second flow rate being less than 40% of the first flow rate.

14. The thermostatic mixing valve of claim 11, wherein the second flow rate being less than 20% of the first flow rate.

15. The thermostatic mixing valve of claim 11, wherein the hot fluid inlet includes a pressure reducing element therein and the cold fluid inlet being absent of an equivalent pressure reducing element, the pressure reducing element having the effect of reducing the second flow rate relative to the first flow rate.

16. The thermostatic mixing valve of claim 15, wherein the hot fluid inlet has an inlet portion that is configured to be connected to an end of a pipe, and the pressure reducing element is positioned downstream of the inlet portion but upstream of the fluid flow regulator.

17. The thermostatic mixing valve of claim 16, wherein the cold fluid inlet has an inlet portion that is configured to be connected to an end of a different pipe, wherein the inlet portion of the hot fluid inlet and the inlet portion of the cold fluid inlet each have an inner diameter, and wherein the inner diameter of the hot fluid inlet the inner diameter of the cold fluid inlet are substantially the same.

18. A thermostatic mixing valve, comprising:
a cold fluid inlet having a cold inlet portion that is configured to be connected to an end of a cold water pipe;
a hot fluid inlet having a hot inlet portion that is configured to be connected to an end of a hot water pipe;
an outlet for passing a flow of tempered fluid;
a fluid flow regulator in fluid communication with the cold fluid inlet and the hot fluid inlet, the fluid flow regulator configured to regulate the relative flow of cold fluid from the cold fluid inlet and hot fluid from the hot fluid inlet to produce the flow of tempered fluid through the outlet; and
a pressure reducing element situated in the hot fluid inlet downstream of the hot inlet portion of the hot fluid inlet and upstream of the fluid flow regulator, wherein the cross-sectional area of the pressure reducing element is less than 80% of the cross-sectional area of the hot inlet portion of the hot fluid inlet.

19. The thermostatic mixing valve of claim 18, wherein the cross-sectional area of the pressure reducing element is less than 60% of the cross-sectional area of the hot inlet portion of the hot fluid inlet.

20. The thermostatic mixing valve of claim 18, wherein the cross-sectional area of the pressure reducing element is less than 40% of the cross-sectional area of the hot inlet portion of the hot fluid inlet.

21. The thermostatic mixing valve of claim 18, wherein the cross-sectional area of the hot inlet portion of the hot fluid inlet is substantially round, and the cross-sectional area of the pressure reducing element is also substantially round.
